(19) United States
(12) Patent Application Publication
(10) Pub. No.: US 2026/0087764 A1
(43) Pub. Date: Mar. 26, 2026

(54) INFORMATION PROCESSING APPARATUS, METHOD OF CONTROLLING SAME, AND STORAGE MEDIUM

(71) Applicant: CANON KABUSHIKI KAISHA, Tokyo (JP)

(72) Inventor: Kanako YANAGISAWA, Tokyo (JP)

(21) Appl. No.: 19/330,827

(22) Filed: Sep. 17, 2025

(30) Foreign Application Priority Data
Sep. 26, 2024 (JP) 2024-167829

(51) Int. Cl. G06V 10/25; G06F 3/14; G06T 3/02; G06T 3/40

(52) U.S. Cl. CPC G06V 10/25; G06F 3/14; G06T 3/02; G06T 3/40; G06V 2201/07

(57) ABSTRACT

An information processing apparatus includes an obtaining unit that obtains an image capturing a work region and an object, a first detection unit that detects a work region from the image, a second detection unit that detects an object region from the image, a frequency map generation unit that generates a frequency map, based on a number of detection times of the object region per grid in the work region, a heat map generation unit that generates a heat map with the frequency map made to correspond with the work region detected by the first detection unit; and a display control unit that displays the heat map on a display device superimposed at a position that is based on the work region.

### BACKGROUND

### Field of the Technology

The present disclosure relates to an information processing apparatus that performs visualization of a work ratio.

### Description of the Related Art

On production sites, image processing sensors are used to check whether or not work standards are satisfied.

For example, Japanese Patent Laid-Open No. 2022-157349 describes a work management system that manages operations including a repeated operation in which the worker repeatedly moves a finishing instrument. The position of a work element such as the finger or a worker or a finishing instrument is identified, a motion vector of the movement of the work element is stored, and the quality of the work is managed.

Depending on the work standards, there are cases where visualization of the ratio of work performed is desired. For example, in the case of color being applied using a paint material or the like, the work ratio can be visualized using color information. Also, even in a case where color information cannot be used, according to the technology described in Japanese Patent Laid-Open No. 2015-186202, work management can be performed via image processing sensors. In the technology described in Japanese Patent Laid-Open No. 2015-186202, from moving body position information and stay information per predetermined measurement interval, a heat map for visualization of the stay information of the moving body is generated.

Accordingly, in a case where there is no change in the relative position between the image processing sensor and the item or where there is no change in color or shape, work management using an image processing sensor is possible.

However, in a case where a part that moved by a belt conveyor is applied with a colorless protective agent or wiped with alcohol, a determination of the ratio of work performed using the change in appearance of the work region cannot be performed with the range of the technology described in the patent literature described above.

Being unable to appropriately obtain the work ratio problematically leads to a determination being unable to be performed for whether or not work is being performed without unevenness or bias with respect to the work region.

### SUMMARY

The present disclosure has been made in light of the problems described above and enables realization of an information processing apparatus that can appropriately visualize a work ratio with respect to a work region.

A first aspect of the present disclosure, there is provided an information processing apparatus comprising: at least one processor or circuit and a memory storing instructions to cause the at least one processor or circuit to perform operations of the following units: an obtaining unit that obtains an image capturing a work region and an object; a first detection unit that detects a work region from the image; a second detection unit that detects an object region from the image; a frequency map generation unit that generates a frequency map, based on a number of detection times of the object region per grid in the work region; a heat map generation unit that generates a heat map with the frequency map made to correspond with the work region detected by the first detection unit; and a display control unit that displays the heat map on a display device superimposed at a position that is based on the work region.

According to a second aspect of the present disclosure, there is provided a method of controlling an information apparatus, the method comprising: obtaining an image capturing a work region and an object; executing first detection that detects a work region from the image; executing second detection that detects an object region from the image; generating a frequency map based on a number of detection times of the object region per grid in the work region; generating a heat map with the frequency map made to correspond with the work region detected by the first detection; and displaying the heat map on a display device superimposed at a position that is based on the work region.

Features of the present disclosure will become apparent from the following description of embodiments with reference to the attached drawings. The following description of embodiments are described by way of example.

### BRIEF DESCRIPTION OF THE DRAWINGS

The accompanying drawings, which are incorporated in and constitute a part of the specification, illustrate embodiments of the present disclosure, and together with the description, serve to explain the principles of the embodiments.

FIG. 1 is a block diagram illustrating an example of the hardware configuration of a recording apparatus according to a first embodiment.

FIG. 2 is a diagram illustrating an example of the schematic configuration of an information processing system including the recording apparatus.

FIG. 3 is a block diagram illustrating an example of the functional configuration of the recording apparatus.

FIG. 4 is a diagram illustrating an example of a work target region obtained by a work region obtaining unit.

FIG. 5 is a diagram for describing processing of an object detection unit.

FIG. 6 is a diagram for describing the processing of a region correction unit.

FIG. 7 is a diagram for describing the processing of a heat map generation unit.

FIG. 8 is a flowchart illustrating the process of generating a heat map.

FIG. 9 is a diagram for describing the processing of a region correction unit according to a second embodiment.

FIG. 10 is a diagram for describing a correction standard of the region correction unit.

FIG. 11 is a diagram illustrating a corrected work-complete region.

FIG. 12 is a diagram for describing the processing of a frequency map generation unit.

FIG. 13 is a diagram for describing the processing for correcting frequency information of a frequency map.

FIG. 14 is a diagram illustrating an example of a heat map display.

FIG. 15 is a block diagram illustrating an example of the functional configuration of a recording apparatus according to a third embodiment.

### DESCRIPTION OF THE EMBODIMENTS

Hereinafter, embodiments will be described in detail with reference to the attached drawings. Note, the following embodiments are not intended to limit the scope of the claims. Multiple features are described in the embodiments, but it is not the case that all such features are required, and multiple such features may be combined as appropriate. Furthermore, in the attached drawings, the same reference numerals are given to the same or similar configurations, and redundant description thereof is omitted.

### First Embodiment

According to the first embodiment described herein, an information processing apparatus that corrects a frequency map indicating a work-complete region where work has been performed for a work target region obtained from a captured image according to the shape of the work target region and displaying the frequency map superimposed as a heat map.

In the present embodiment described herein, the processing is executed to correct a heat map display using the vertical and horizontal size of the work target region.

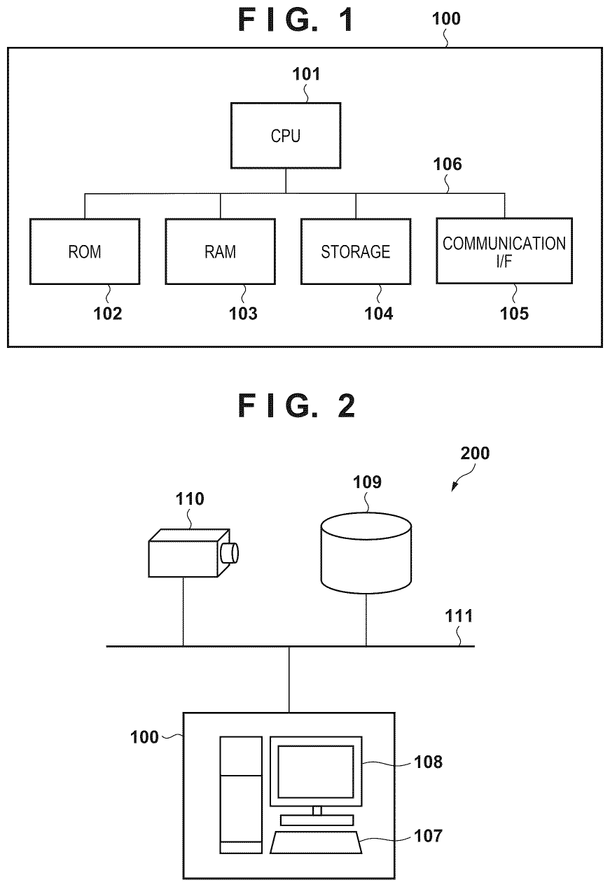

FIG. 1 is a block diagram illustrating an example of the hardware configuration of a recording apparatus 100 according to the present first embodiment.

The recording apparatus 100 includes a CPU 101, a ROM 102, a RAM 103, a storage 104, and a communication I/F 105. The CPU 101, the ROM 102, the RAM 103, the storage 104, and the communication I/F 105 are connected to an internal bus 106.

The CPU 101 is a central processing unit that comprehensively controls the operations in the recording apparatus 100. The ROM 102 is a non-volatile memory that stores programs required for the CPU 101 to execute processing, various types of initial settings data, and the like. The RAM 103 is a volatile memory that functions as a main memory of the CPU 101, a working area, and the like and temporarily stores programs, image data, and the like. Various types of function operations are implemented by the CPU 101 loading a required program or the like from the ROM 102 onto the RAM 103 and executing the program or the like when executing processing.

The storage 104 is a storage device with a large-capacity compared to the RAM 103, and a hard disk drive (HDD) or a solid state drive (SSD) is used, for example. The storage 104 stores the OS (basic software) executed by the CPU 101. Also stored are various types of programs for performing work target region obtaining, work-complete region obtaining, region correction, frequency map generation, and heat map generation according to the present embodiment; various types of parameters relating to the programs; data; and the like. The storage 104 can also store image data obtained via a network.

When the CPU 101 is started up by the power being turned on, for example, the CPU 101 executes a start-up program stored in the ROM 102. The start-up program is configured to read out the OS stored in the storage 104 and load the OS onto the RAM 103.

After OS start up, for example, the user may use an operation unit 107 illustrated in FIG. 2 or the like to instruct a work target region obtaining program, a work-complete region obtaining program, a region correction program, a frequency map generation program, and a heat map generation program to be run. At this time, the CPU 101 reads out each program from the storage 104 and loads them onto the RAM 103. In this manner, the CPU 101 generates a frequency map of the work-complete regions from the corrected work-complete regions. Also, the various types of data used in the operations of the program for superimposing the heat map to match the work target region of the captured image are also stored and read out onto the RAM 103.

The communication I/F 105 is a local area network (LAN) interface, for example, for communicating with a network camera, another computer, and the like via the network.

Note that the images used in each program and the various types of used in each of the work-complete region obtaining program, the region correction program, the frequency map generation program, and the heat map generation program according to the present embodiment may be obtained via the network.

The recording apparatus 100 may be configured of a single apparatus with the configuration illustrated in FIG. 1, such as a personal computer (PC), tablet PC, or the like. However, the configuration illustrated in FIG. 1 may be configured of separate pieces of hardware. In other words, the recording apparatus 100 may be configured of a plurality of apparatuses. Also, the computational processing for various types of analysis and determination may be executed using a GPU (not illustrated).

FIG. 2 is a diagram illustrating an example of the schematic configuration of an information processing system 200 that includes the recording apparatus 100 according to the present embodiment.

The information processing system 200 includes the recording apparatus 100, a storage apparatus 109, and a camera 110.

The recording apparatus 100, the storage apparatus 109, and the camera 110 are connected in a communication-enabling manner to one another via a network 111.

The network 111 may be a LAN, for example. Note that as long as the network 111 is configured to enable communication between the recording apparatus 100, the camera 110, and the storage apparatus 109, any communication standard, scale, and configuration may be used. Also, the physical connection mode to the network 111 may be wired or wireless. Furthermore, the connection between the recording apparatus 100, the storage apparatus 109, and the camera 110 is not limited to being via the network 111, and a connection via USB or the like may be used.

The recording apparatus 100 may include the operation unit 107 and a display unit 108 in addition to the configuration illustrated in FIG. 1 as part of the hardware configuration. Here, the operation unit 107 includes a pointing device such as a keyboard or mouse. Also, the display unit 108 includes a monitor such as a liquid crystal display (LCD) and is a display device for a user (operator) to view when operating the recording apparatus 100, for example.

The camera 110 is a network camera, for example, and is an image capture apparatus with a function of capturing images in a field of view and transmitting the captured images to the recording apparatus 100 via the network 111. The camera 110 may be a pan-tilt-zoom (PTZ) camera configured to be able to change the imaging area. In this case, the camera 110 may include a function of transmitting imaging parameter information including the imaging direction and imaging angle including pan angle, tilt angle, and zoom magnification to the recording apparatus 100 via the network 111.

Also, in the present embodiment described herein, the camera 110 is a network camera functioning as a surveillance camera. However, no such limitation is intended. For example, the camera 110 may be a digital still camera, a digital video camera, a smartphone or tablet terminal with a camera function, a camera for industrial use, an in-vehicle camera, a wearable camera, or the like. The recording apparatus 100 receives the captured image captured by the camera 110 as an input image from the camera 110 via the network 111 and executes the processing described below on the received input image.

Note that the camera 110 may transmit the captured image to the storage apparatus 109, the storage device of another apparatus, or the like via the network 111. In this case, the recording apparatus 100 may receive the captured image stored in the storage apparatus 109, the storage device of another apparatus, or the like as an input image via the network 111. Here, input image is not limited to a captured image captured by the camera 110. For example, an input image may be a partial image corresponding to a portion of a captured image. Also, the configuration of the information processing system 200 illustrated in FIG. 2 is merely an example, and the devices may be integrally formed as in a tablet PC and the like. In other words, the recording apparatus 100 may be provided with the function of the camera 110.

The recording apparatus 100 obtains a work target region and a work-complete region from the image obtained via the camera 110. A frequency map is generated from both obtained regions, the heat map display is corrected according to the frequency map and the shape of the work target region, and the heat map is displayed superimposed on the image.

A work target region refers to a work area, component, or the like of an object that is the target for work. A work-complete region is a region or the like where a hand of a worker or a tool for work is detected.

To generate a frequency map, the number of times work is performed in any region of the work target region is counted. The number of times work is performed is calculate using the number of times a hand of a worker or a tool for work is detected. Control is performed to display the generated heat map on a monitor or the like via the display unit 108 to allow the user to check the heat map.

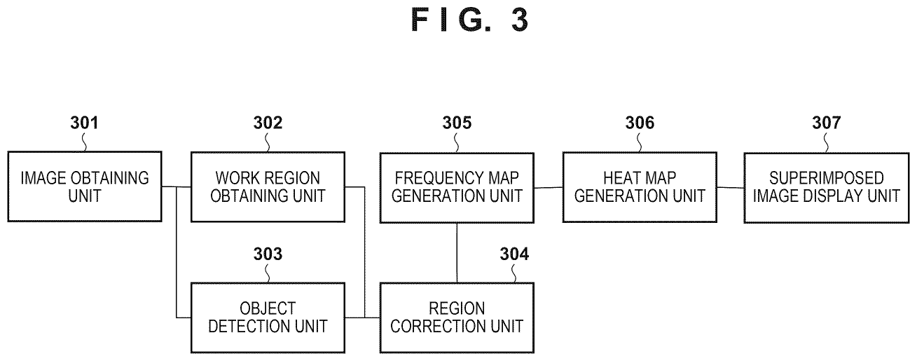

FIG. 3 is a block diagram illustrating an example of the functional configuration of the recording apparatus 100 according to the present embodiment.

As illustrated in FIG. 3, the recording apparatus 100 includes an image obtaining unit 301, a work region obtaining unit 302, an object detection unit 303, a region correction unit 304, a frequency map generation unit 305, a heat map generation unit 306, and a superimposed image display unit 307.

Note that at least one or more of the functions of each component of the recording apparatus 100 illustrated in FIG. 3 can be implemented by the CPU 101 executing a program. However, of the components of the recording apparatus 100 illustrated in FIG. 3, at least one or more may operate as dedicated hardware. In this case, the dedicated hardware operates on the basis of control by the CPU 101.

The functions of the recording apparatus 100 will be described below using FIG. 3.

The image obtaining unit 301 receives an image obtained via the camera 110 or the like.

The work region obtaining unit 302 detects a work target region from the image obtained by the image obtaining unit 301.

The object detection unit 303 detects a certain object from the image obtained by the image obtaining unit 301. The object detected here may be the hand of a person performing work, a tool used in the work, a device, or the like.

The region correction unit 304 performs shape conversion of the work target region and the work-complete region obtained by the work region obtaining unit 302 and the object detection unit 303 on the basis of a correction standard stored in the region correction unit 304 set in advance.

The frequency map generation unit 305 generates a frequency map on the basis of the work target region and the work-complete region with a shape corrected on the basis of the correction standard. For example, if a moving part in a belt conveyor is set as a work target region and an image is obtained via the image obtaining unit 301 of the recording apparatus 100 at a fixed position, there may be a difference in the size between the part detected from an image obtained at one point in time and the part detected from an image obtained at a different point in time. This also applies in a case where a region including the hand of a person working at the belt conveyor is set as a work-complete region and an image is obtained via the image obtaining unit 301 of the recording apparatus 100 at a fixed position. In such cases, by generating a frequency map on the basis of the work target region and the work-complete region with the difference in size of the region including the part or hand corrected, a work ratio can be appropriately obtained.

The heat map generation unit 306 generates a heat map by correcting the shape of the frequency map generated by the frequency map generation unit 305 to match the work target region in the image obtained by the image obtaining unit 301. In this manner, when generating the heat map, the shape of the frequency map is corrected to match the work target region in the image obtained by the image obtaining unit 301 and not the work target region with its shape corrected on the basis of the correction standard. Accordingly, a heat map for the work target region that the user is viewing in real time can be generated.

The superimposed image display unit 307 displays the heat map generated by the heat map generation unit 306 superimposed at a position based on the work target region in the image. For example, in a case where a moving part in a belt conveyor is set as the work target region, the generated heat map is displayed superimposed on the image matching the movement of the work target region. In other words, the generated heat map is displayed moving to match the movement of the work target region. Accordingly, even in the case of a moving work target region, the user can appropriately obtain a work ratio for the work target region.

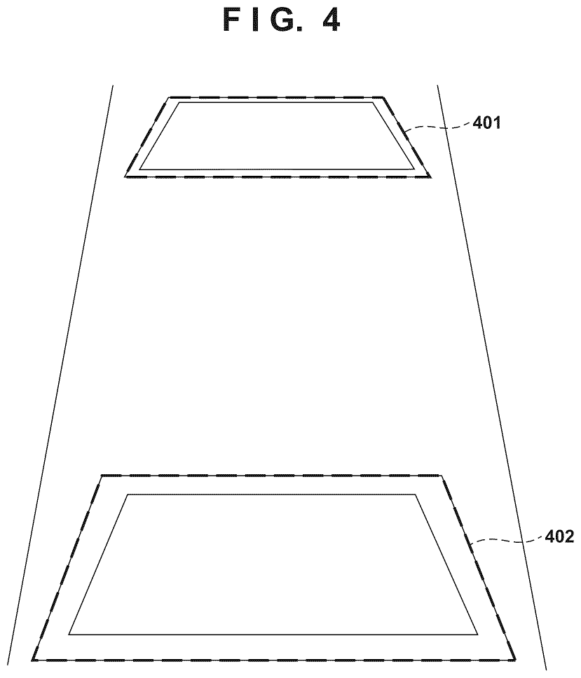

The work region obtaining unit 302, the object detection unit 303, the region correction unit 304, the frequency map generation unit 305, and the heat map generation unit 306 corresponding to the functions of the recording apparatus 100 will be described in detail below using FIGS. 4, 5, 6, and 7.

The work target region obtained by the work region obtaining unit 302 is a part or a region indicating an area of work corresponding to the work target, for example. The feature points of the part or region indicating an area of work is extracted, and a region enclosed by the feature points is set to the work target region. The feature points may be extracted using scale-invariant feature transformation (SIFT), and a part or a corner part of region corresponding to the target may be extracted. Also, for the feature point extraction, a different method may be used, and the type is not limited.

Also, a marker such as a 2D barcode or the like may be used to obtain the work target region. In this case, a marker is attached to the part or region corresponding to the work target in advance, and the coordinate points indicating the area of the region is obtained by detecting the marker. The method for detecting the region is not limited to only this method, and a method including detecting the region via deep learning may be used, for example.

FIG. 4 illustrates an example of a work target region obtained by the work region obtaining unit 302. In FIG. 4, a region 401 and a region 402 indicate an aluminum sash, which is a building material used as a window frame. The work expected to be performed here is a worker using a work cloth to wipe an aluminum sash moving on a belt conveyor.

Also, depending on the obtained image, there may be cases where the feature point forming the work target region cannot be correctly obtained. For example, in some cases, the body of the worker may obscure a part of the image or the like.

In a case where the number of feature points obtained this time is equal to or greater than a certain number and the difference between the number of feature points of the obtained shape and the number of feature points of the work target region previously obtained is equal to or less than a certain value, the work target region previously obtained may be used as a substitute. The determination of the difference between the shape obtained from the obtained feature points and the work target region previously obtained may be performed on the basis of whether or not the difference in Euclidean distance of the coordinate points is equal to or less than a threshold. The Euclidean distance of the coordinate points may be calculated in association with each feature point.

A certain object to be detected by the object detection unit 303 may be the hand of a worker, a device for the work, or the like, for example. When performing work, the hand of a worker or a device may overlap with the work region, causing the position where a certain object is detected to be determined as a work-complete region. Accordingly, even in a case where a colorless protective agent is applied to the part or the part is wiped with alcohol, the region including the position where a certain object is detected is determined as a work-complete region, allowing the work ratio is be appropriately obtained.

Template matching with a template image as the target object may be used in detecting a certain object. Also, the target object may be detected using deep learning.

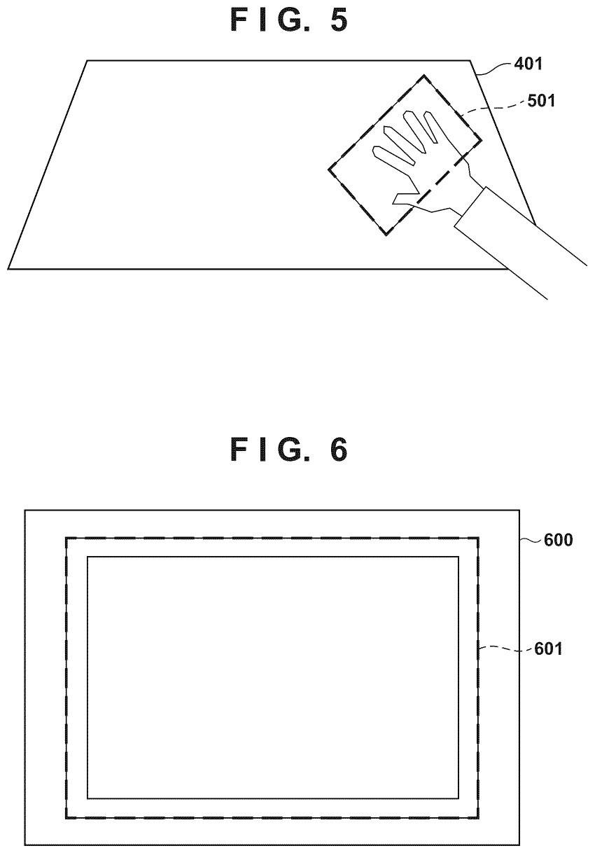

For example, FIG. 5 illustrates an example of an object being detected using a model trained in advance for a work cloth. The region where the work cloth is detected is a region 501.

The region generated by the region correction unit 304 is calculated using the work target region obtained by the work region obtaining unit 302, the work-complete region obtained by the object detection unit 303, and the correction standard set in advance. The correction standard set in advance may be a shape calculated from a model image including the work target region input in advance. The correction standard may also be a work target region initially obtained by executing the present processing. The correction standard may also be a shape fixed and held inside the system.

An example of calculating a correction standard from a model image will now be described using FIG. 6.

FIG. 6 illustrates an image 600 captured from above the work target region. The work target region of the image 600 is indicated as a region 601. In a case where the region 601 is the correction standard, a grid for a frequency map is generated for the correction standard.

The grid of a frequency map may be generated by dividing the bounding box of the region corresponding to the correction standard in the vertical direction and the horizontal direction. The unit for dividing may be designated at the discretion of the user or may be determined depending on the physical size of the work target region and detection object. For example, a heat map with units of 10 cm and 1 m for the lower side of the region 601 is intended to be generated. In this case, if the length of the lower side in the image of the work target region is 500 pixels, the block size in the horizontal direction can be set to 50 pixels. The same can be applied in regard to the vertical direction to calculate the block size.

In other words, to calculate the block size, a side forming the region in the actual object of a work target object and a side forming the work target region of the captured image are associated together and the length is compared. The unit for dividing may using the smallest pixel of the captured image as a reference.

The correction standard may be stored in the storage apparatus 109 and read out from the storage apparatus 109 when processing by the region correction unit 304 is executed or loaded onto the memory of the recording apparatus 100 before execution of the processing by the region correction unit 304.

In the region correction unit 304, the work target region and the work-complete region in the work target region are shape-corrected to match the correction standard.

In the case of performing shape correction of the region 601, which is the correction standard generated as described above, and the region 401, which is the work target region, and the region 501, which is the work-complete region, the region 401 and the region 501 are scaled to match the size of the region 601 in the vertical direction and the horizontal direction.

The frequency map generation unit 305 applies the grid obtained at the time of the generation of the region 601 to the corrected work target region and the corrected work-complete region obtained via scaling and determines that the grid overlapping the work-complete region is detected.

Whether or not the work-complete region is included may be determined on the basis of whether or not the ratio of the work-complete region with respect to each grid is greater than a threshold. When each grid is determined as work complete, the number of detection times of the frequency map counts up.

The result obtained from counting is stored as numerical data for each grid. For example, using the upper left of the grid as a reference and assigning numbers such as grid 1, 2, and so on, the number of detections for each grid may be associated and stored.

A frequency map of a series of work situations converted to numerical values can be generated from the plurality of work target regions and work-complete regions obtained by repeating the processing of the image obtaining unit 301, the work region obtaining unit 302, and the object detection unit 303.

The heat map generation unit 306 generates the frequency map information obtained by the frequency map generation unit 305 as a heat map using a color scale. At this time, the heat map is displayed with the shape of the frequency map scaled to match the work region obtaining unit 302.

Also, in a case where the feature points forming the work target region cannot be correctly obtained and a previously obtained work target region is used as a substitute, the shape is scaled to match the previously obtained work target region.

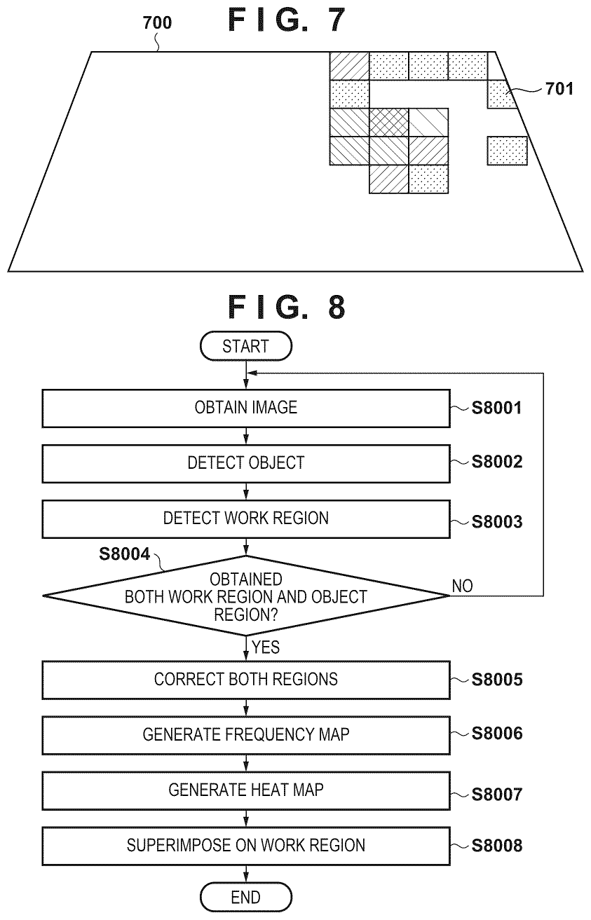

FIG. 7 illustrates an image 700 of the heat map superimposed on the work target region and a grid 701 of the heat map.

The grid 701 is at the edge of the work target region, and thus a portion of the grid is not included in the work region. In such a case, only the portion included in the work region is displayed as a grid of the heat map.

Each function of the recording apparatus 100 illustrated in FIG. 3 will be described below in detail with reference to the flowchart illustrated in FIG. 8. The processing of FIG. 8 is started when the user starts up the information processing system 200. Note that S indicates the step number.

In S8001, the image obtaining unit 301 obtains an image. The processing of S8002 is executed using the image obtained here.

In S8002, the object detection unit 303 detects an object for identifying a work-complete region matching the work being performed. In the example illustrated in FIG. 5, this is a cloth for wiping an aluminum sash.

In S8003, the work region obtaining unit 302 detects a work target region matching the work being performed. In the illustrated in FIG. 4, this is an aluminum sash.

Note that in FIG. 8, S8002 and S8003 are executed in this order, but the detection order may be reversed.

In S8004, the CPU 101 determines whether or not both a work region and an object have been detected in the processing of S8002 and S8003. If at least one has not been detected (no in S8004), the processing returns to S8001, an image is re-obtained, and the processing of S8001 onward is executed.

If both have been detected (yes in S8004), the CPU 101 executes the processing of S8005.

In S8005, the region correction unit 304 executes correction processing. Here, shape correction of the region is executed using the object region and the work region obtained in S8002 and S8003 and a correction standard.

In S8006, the frequency map generation unit 305 generates a frequency map using the region generated in S8005. By repeating the processing of S8001 to S8005 of the present flowchart, a frequency map indicating the state of work being performed on the work region can be generated.

In the processing of S8007, for the frequency map generated in S8006, reverse shape correction from the correction standard to the work region is performed to generate a heat map.

In S8008, the superimposed image display unit 307 superimposes the heat map on the image. The heat map generated in S8007 is superimposed on the work region obtained by executing the processing of S8003 on the image obtained in S8001. The result of the superimposition is presented to the user via a display provided in the display unit 108.

By repeating the processing of S8001 to S8008, the ratio of work to the work region matching the work situation can be visualized.

Though not illustrated in FIG. 8, the determination of whether or not to end the processing of S8008 may be performed on the basis of the heat map exceeding a certain numerical value for a certain area of greater of the work target region, for example. Determination may also be performed when the work target region detection processing and the object detection processing have not been performed for a certain amount of time. Determination may also be performed when a certain amount of time has passed from the time of the initial object detection.

In the first embodiment, when the frequency map is generated, the work target region and the work-complete region with shapes corrected on the basis of the correction standard are used. However, in a case such as when the movement distance of the part by the belt conveyor is short and the size of the part to be detected from the image does not change even when the part is moved, the work target region and the work-complete region without corrected shapes may be used.

In such a case, the frequency map is generated on the basis of the work target region and the work-complete region obtained by the work region obtaining unit 302 and the object detection unit 303. Also, the heat map is generated by adjusting the position of the generated frequency map to match the position of the work target region in the image obtained by the image obtaining unit 301. Furthermore, the generated heat map is displayed superimposed at the position based on the work target region in the image. Accordingly, even in a case where the size of the part to be detected from the image does not change but the position of the part changes, the work ratio for the work target region can be appropriately visualized for the user.

### Second Embodiment

In the method according to the first embodiment described above, the frequency map is corrected scaling the work target region in the vertical direction and the horizontal direction and the heat map is displayed matching the work target region.

In the second embodiment, shape correction in a case where the shape of the work target region is complex, where there is a tilt direction angle between the camera and the work target region, and the like will be described.

In the present embodiment, the processing of the region correction unit 304, the frequency map generation unit 305, and the heat map generation unit 306 will be described. The image obtaining unit, the work region obtaining unit 302, the object detection unit 303, and the superimposed image display unit 307 are as described in the first embodiment in terms of content and thus will not be described.

The correction standard stored in advance in the region correction unit 304 is as described in the first embodiment in terms of content.

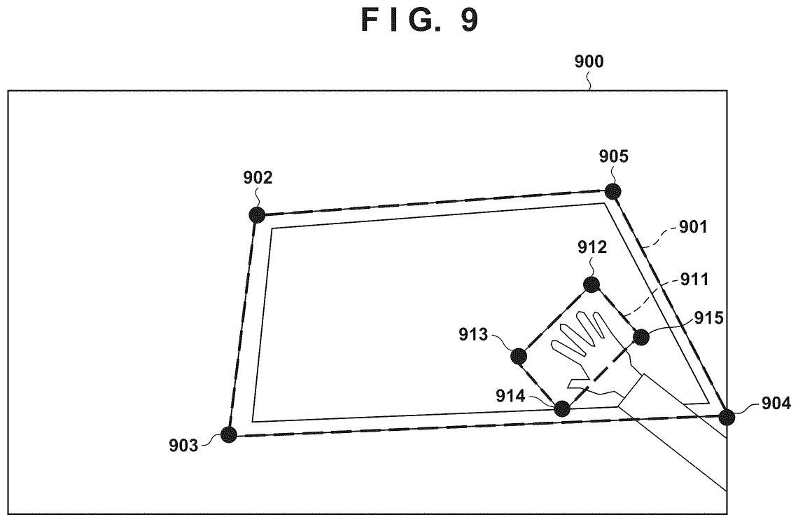

In the region correction unit 304, the work target region obtained by the work region obtaining unit 302 including the object detection region of the object detection unit 303 is normalized to the size (correction standard) of a certain standard region. How normalization is performed will now be described using an example of correcting using projective transformation and FIGS. 9, 10, 11, 12, and 13.

FIG. 9 illustrates a captured image 900 obtained by the camera 110. The captured image 900 includes a region 901 which is a work target region obtained by the work region obtaining unit 302. The region 901 is made up of coordinate points 902, 903, 904, and 905.

Also, the captured image 900 includes a region 911 which is a work-complete region detected by the object detection unit 303. The region 911 is made up of coordinate points 912, 913, 914, and 915. The region correction unit 304 stores the correction standard set in advance.

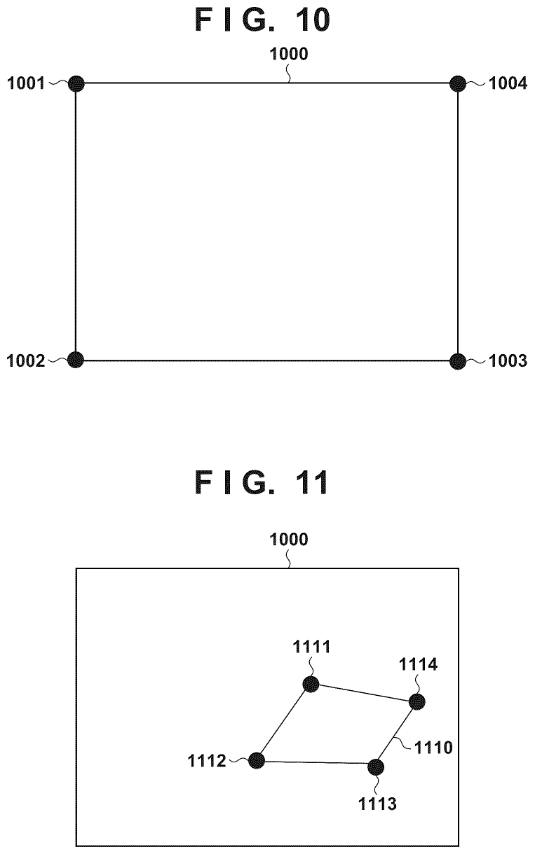

The correction standard is illustrated in FIG. 10. FIG. 10 illustrates a region 1000 corresponding to the correction standard and coordinate points 1001, 1002, 1003, and 1004 making up the region 1000.

In the present embodiment, the region 1000 is a region of a determined size held inside the system and may be stored in the storage apparatus 109 and read out by the recording apparatus 100 when processing by the region correction unit 304 is executed.

The conversion matrix for projective transformation is calculated from the work target region and the correction standard. The coordinate points 902 and 1001, the coordinate points 903 and 1002, the coordinate points 904 and 1003, and the coordinate points 905 and 1004 are associated together and simultaneous equations are generated, with the conversion matrix being calculated from the obtained solutions.

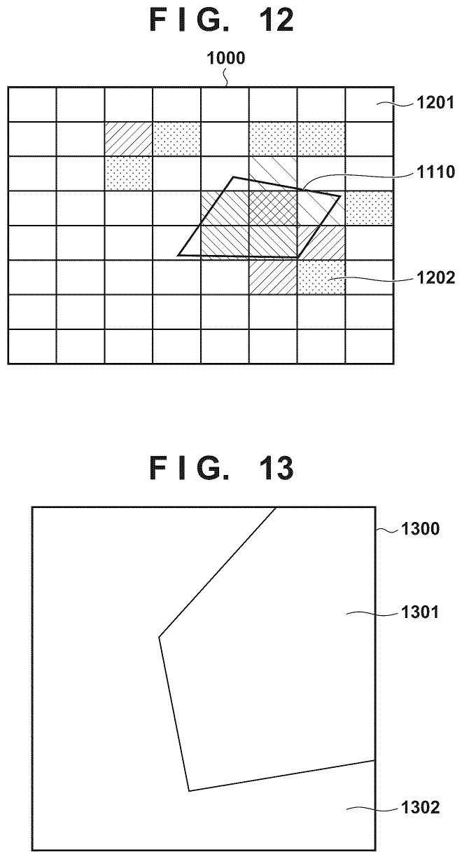

By applying the conversion matrix obtained here to the work-complete region, a corrected work-complete region matching the region 1000 corresponding to the correction standard can be obtained. The corrected work-complete region can be illustrated as in FIG. 11.

FIG. 11 illustrates a region 1110 in the region 1000 which is a corrected work-complete region. Also, the region 1110 is made up of coordinate points 1111, 1112, 1113, and 1114. The coordinate points 1111, 1112, 1113, and 1114 are associated with the coordinate points 912, 913, 914, and 915 of the captured image 900.

Also, in the present embodiment, a method for performing projective transformation on a work target region made up of four points has been described. However, the coordinate points that make up the work target region may be three points or five or more. In such a case, the bounding box of the work target region, the coordinate points making up the bounding box, and the coordinate points making up the bounding box of the correction standard are obtained, and projective transformation based on the obtained coordinate points is performed to obtain a conversion matrix.

The frequency map generated by the frequency map generation unit 305 is generated using the region corresponding to the correction standard as a reference. The frequency map generation method will now be described using the example of a frequency map illustrated in FIG. 12. FIG. 12 illustrates a grid 1201 indicating the grid forming the frequency map and a frequency region 1202 indicating frequency information.

The region 1000 is divided by the grid 1201 into predetermined blocks. Whether or not a work-complete region is included in each grid 1201 is determined. Whether or not the work-complete region is included may be determined on the basis of whether or not the ratio of the work-complete region with respect to each grid is greater than a threshold. When each grid is determined as work complete, the number of detection times of the frequency map counts up.

A captured image is repeatedly obtained and a corrected work target region and work-complete region are generated for each captured image to generate a frequency map. The region obtained as a result of counting corresponds to a region 1202, for example.

According to the present embodiment described herein, the result obtained from counting is illustrated as the region 1202. However, the result may be stored as numerical data for each grid by the frequency map generation unit 305.

For example, using the upper left of the grid as a reference and assigning numbers such as grid 1, 2, and so on, the number of detections for each grid may be associated and stored.

The heat map generation unit 306 generates a heat map by performing shape correction of the frequency map generated by the frequency map generation unit 305 to match the work target region in the image obtained by the image obtaining unit 301.

An example of converting the frequency map illustrated by the region 1000 and the region 1202 to match the work target region 901 illustrated in FIG. 9 will now be described.

Conversion from the region 1000 to the region 901 can be performed using the inverse matrix of the conversion matrix obtained by the region correction unit 304.

A post-conversion heat map is generated from frequency map information for display matching the work target region obtained by converting the region 1202 of each grid of the frequency map.

In order to generate a frequency map for display matching the region 901, the shape of each block needs to be scaled according to the shape of the work target region. For example, in the case of a shape such as that of the region 901, for the upper portion of the shape, the grid size of the region 1202 needs to the reduced, and for the lower portion of the shape, the grid size needs to be enlarged.

The heat map display information may be generated with the grid size scaled, or the minimum size of the grid size for display may be changed according to the shape of the work region of the heat map display target.

For example, a minimum grid size of the frequency map for the heat map may be determined to match the minimum size of the region of each grid obtained when converting the region 1202 of each block of the frequency map using the inverse matrix of the conversion matrix obtained by the region correction unit 304. Also, the frequency information may be converted to match the grid generated to match the work target region.

The frequency information conversion method will now be described on the basis of a grid 1300, which is a portion of a grid generated to match the work target region illustrated in FIG. 13 and frequency information 1301 and 1302.

The frequency information 1301 and 1302 are portions of the grid of the frequency map obtained by conversion to match the work target region obtained by converting from the region 1000 to the region 901.

In a case where the frequency information differs between the frequency information 1301 and 1302, a numerical value of the grid 1300 may be determined to match the ratio of the region with respect to the grid. In a case where the region ratio of the frequency information 1301 and 1302 is a: b, the numerical value of the frequency information 1301 is n, and the numerical value of the frequency information 1302 is m, the numerical value obtained via (a/a+b)×m+(b/a+b)×n may be calculated as the frequency information of the grid 1300. Alternatively, the value of the largest region from among the regions of the frequency information 1301 and 1302 may be used.

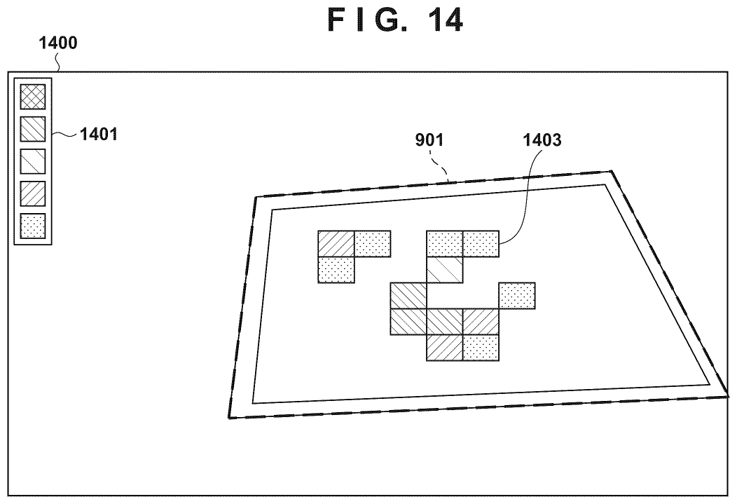

An example of the heat map display generated according to the second embodiment is illustrated in FIG. 14. A color scale 1401, the work target region 901, and a heat map region 1403 are displayed against a captured image 1400.

The color scale may be represented by hue or may be represented by the brightness of a certain color. In FIGS. 14, 5 levels are illustrated, but the number of level is not limited.

Also, in the second embodiment, projective transformation is used as the normalization method, but how the normalization is implemented is not limited to only projective transformation. For example, free-form deformation (FFD), affine transformation, and the like may be used.

### Third Embodiment

In the first embodiment and the second embodiment, the heat map is superimposed on the work target region of the captured image, but the heat map may be superimposed on a model image obtained in advance, for example.

At this time, the heat map generation unit 306 deforms the frequency map obtained by the frequency map generation unit 305 to match the work target region of the model image. The deformation method may be similar to the methods described in the first embodiment and the second embodiment.

Also, the display method for the heat map display may change depending on the image on which the heat map is to be superimposed. For example, in a case where the size of the work target region is equal to or less than a threshold, the transparency of the color scale of the heat map may be reduced, and in a case where the size of the work target region exceeds the threshold, the transparency of the color scale of the heat map may be increased. Also, the thickness of the frame surrounding the region may be changed depending on the size of the work target region. In a case where the work target region is small, the thickness may be thin, and in a case where the work target region is larger, the thickness may be thick, and in this manner the visibility of the heat map display in the work target region can be adjusted.

### Fourth Embodiment

In the fourth embodiment, a mechanism for notifying a user on the basis of the obtained frequency map and heat map will be described.

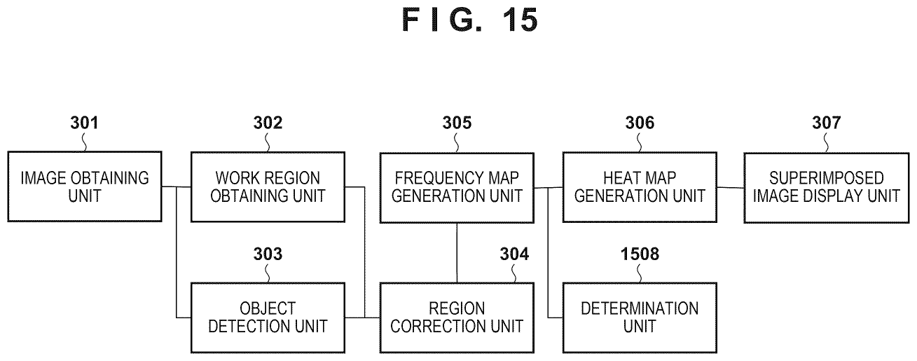

As illustrated in FIG. 15, the function of a determination unit 1508 is provided to the recording apparatus 100 of FIG. 3. The determination unit 1508 obtains in advance threshold information corresponding to a standard for notifying the user. The threshold information is a numerical value for a ratio of a region with a number of detection times obtained from the frequency map that is greater than a certain value with respect to the entire frequency map. For example, the threshold may be the region with the number of detection times that is greater than three being 70% or greater of the frequency map.

In a case where the threshold is exceeded, the user is notified that work is complete. The notification method may use a warning lamp (not illustrated) or characters or an icon indicating work complete may be displayed on the display unit 108.

Also, in a case where the threshold is not exceeded and the work target region and the work-complete region have not been detected for a certain amount of time, the user may be notified.

Also, the threshold may be a numerical value for the difference between the maximum value and the minimum value of the number of detection times of the frequency map.

By providing a threshold for the work ratio in this manner and providing a notification method for when the threshold is exceeded and not, in addition to visualization of the work situation, the user (worker) can be shown that the work has been correctly performed or not correctly performed.

Also, by defining the threshold as a numerical value for the difference between the maximum value and the minimum value of the number of detection times of the frequency map, the user (worker) can be shown that there in unevenness in the work. Note that the notification method and threshold setting method may be changed as appropriate regardless of the foregoing.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the present disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2024-167829, filed Sep. 26, 2024, which is hereby incorporated by reference herein in its entirety.

What is claimed is:

1. An information processing apparatus comprising:
at least one processor or circuit and a memory storing instructions to cause the at least one processor or circuit to perform operations of the following units:
an obtaining unit that obtains an image capturing a work region and an object;
a first detection unit that detects a work region from the image;
a second detection unit that detects an object region from the image;
a frequency map generation unit that generates a frequency map, based on a number of detection times of the object region per grid in the work region;
a heat map generation unit that generates a heat map with the frequency map made to correspond with the work region detected by the first detection unit; and
a display control unit that displays the heat map on a display device superimposed at a position that is based on the work region.

2. The information processing apparatus according to claim 1, wherein the at least one processor or circuit is configured to further function as a correction unit that corrects a shape of the work region and the object region.

3. The information processing apparatus according to claim 2, wherein the frequency map generation unit generates a frequency map, based on the number of detection times of the object region per grid in the work region corrected by the correction unit.

4. The information processing apparatus according to claim 2, wherein the correction unit corrects a shape of the work region and the object region by enlarging or reducing the shape of the work region and the shape of the object region in a vertical or horizontal direction to match a standard region for correcting a region.

5. The information processing apparatus according to claim 2, wherein the correction unit corrects a shape of the work region and the object region by normalizing the shape of the work region and the shape of the object region to match a standard region for correcting a region.

6. The information processing apparatus according to claim 5, wherein the correction unit normalizes the work region and the object region to match the standard region, and the heat map generation unit converts the frequency map to correspond to the work region of the image obtained by the obtaining unit from the standard region.

7. The information processing apparatus according to claim 5, wherein the correction unit performs the normalizing via projective transformation.

8. The information processing apparatus according to claim 5, wherein the correction unit performs the normalizing via free-form deformation.

9. The information processing apparatus according to claim 5, wherein the correction unit performs the normalizing via affine transformation.

10. The information processing apparatus according to claim 5, wherein the standard region is determined based on the work region captured in advance.

11. The information processing apparatus according to claim 1, wherein in a case where, compared to the work region detected in a previous detection, there are coordinate points not detected in a work region detected in a current detection and a difference between the number of coordinate points detected in a current detection and the number of coordinate points detected in a previous detection is equal to or less than a threshold, the first detection unit uses the work region detected in a previous detection as a work region detected in a current detection.

12. The information processing apparatus according to claim 1, wherein the heat map generation unit updates a size of the grid of the heat map according to a shape the work region detected by the first detection unit.

13. The information processing apparatus according to claim 1, wherein the heat map generation unit updates at least one of a display color and line thickness according to a shape of a work region detected by the first detection unit.

14. The information processing apparatus according to claim 1, wherein the at least one processor or circuit is configured to further function as a warning unit that issues a warning in a case where a frequency and the number of each grid in the frequency map is not greater than a threshold and the work region and the object region has not been detected for a certain amount of time.

15. A method of controlling an information apparatus, the method comprising:
obtaining an image capturing a work region and an object;
executing first detection that detects a work region from the image;
executing second detection that detects an object region from the image;
generating a frequency map based on a number of detection times of the object region per grid in the work region;
generating a heat map with the frequency map made to correspond with the work region detected by the first detection; and
displaying the heat map on a display device superimposed at a position that is based on the work region.

16. A non-transitory computer-readable storage medium storing a program for causing a computer to execute a method of controlling an information processing apparatus, the method comprising:
obtaining an image capturing a work region and an object;
executing first detection that detects a work region from the image;
executing second detection that detects an object region from the image;
generating a frequency map based on a number of detection times of the object region per grid in the work region;
generating a heat map with the frequency map made to correspond with the work region detected by the first detection; and
displaying the heat map on a display device superimposed at a position that is based on the work region.
